(19) United States
(12) Patent Application Publication
(10) Pub. No.: US 2008/0071635 A1
(43) Pub. Date: Mar. 20, 2008

(54) Online transaction system

(75) Inventor: Kenn Tat Ong, Petaling Jaya (MY)

Correspondence Address: AMSTER, ROTHSTEIN & EBENSTEIN LLP, 90 PARK AVENUE, NEW YORK, NY, 10016, US

(73) Assignee: Reapfield Technology Sdn. Bhd

(21) Appl. No.: 11/807,663

(22) Filed: May 30, 2007

(30) Foreign Application Priority Data
Sep. 15, 2006 (MY) PI 20064150

(51) Int. Cl. G06Q 30/00; G06F 17/00; H04L 9/00; G06F 17/30

(52) U.S. Cl. 705/26; 705/10; 705/67; 726/14

(57) ABSTRACT

The present invention relates to an online transaction system (10). The system (10) enables a registered merchant to post his product or service and enables a registered purchaser to view and purchase the product and service. The system (10) includes a web server (12) and/or a database server (14) and a first remote computer (16) connecting the web server (12) and/or database server (14) to a security authentication server (18).

### CROSS-REFERENCE TO RELATED APPLICATIONS

This patent application claims priority benefits pursuant to 35 U.S.C. §119(a)-(d) to co-pending Malaysian Patent Application Serial No. PI 20064150, which was filed Sep. 15, 2006 with the Intellectual Property Corporation of Malaysia, the disclosure of which is incorporated by reference herein in its entirety.

### FIELD OF THE INVENTION

The present invention relates to an online transaction system.

### BACKGROUND OF THE INVENTION

In the past several years since the introduction of the Internet, there has been an explosive growth in the use of globally linked network of computers. As a result, the world has seen that online purchase and sale of products and services has increased tremendously. The introduction and advancement of information technology, particularly online transactions between computer users have further promoted an expansion from local markets to national markets, regional markets and international markets.

The availability of the Internet across many parts of the world has opened markets previously deemed too remote and unprofitable. Further, access to the Internet has empowered real-time access to buyers seeking sellers of products, and sellers seeking buyers for products, which was beyond imagination a mere generation ago. Such empowerment has resulted in the rapid development of business transactions on the Internet, with direct marketing and online sales.

As the cost of living and inflation increase, consumers are becoming more price sensitive and are looking for ways to purchase goods at lower prices. The nature of sales is such that bulk purchases will always gain discounts. The sellers benefit from bulk sales by selling larger quantities of products or services in a relatively shorter time. Accordingly, there is a need for an online business transaction platform which provides a demand collection system that connects people for the purpose of joining forces and acquiring products and services at lower retail prices.

### SUMMARY OF THE INVENTION

Accordingly, the present invention provides an online transaction system which enables a registered merchant to post his product or service and which enables a registered purchaser to view and purchase the product and service. The system includes at least a web server and/or at least a database server, and a first remote computer connecting the web server and/or database server to a security authentication server.

The present invention consists of several novel features and a combination of parts hereinafter fully described and illustrated with reference to the accompanying drawings, it being understood that various changes in the details may be made without departing from the scope of the invention or sacrificing any of the advantages of the present invention.

### BRIEF DESCRIPTION OF THE ACCOMPANYING DRAWINGS

For the purpose of facilitating and understanding the present invention, there is illustrated in the accompanying drawings, from an inspection of which, when considered in connection with the following description, the invention, its construction and operation, and many of its advantages would be readily understood and appreciated.

FIG. 1 is a schematic illustrating the online transaction system according to the preferred embodiments of the present invention; and

FIG. 2 is a flow chart illustrating the steps associated with an online transaction conducted in accordance with the system described in FIG. 1.

### DETAILED DESCRIPTION OF THE PREFERRED EMBODIMENTS

The present invention relates to an online transaction system. Hereinafter, this specification will describe the system according to the preferred embodiments of the present invention. However, it is to be understood that this description of the preferred embodiments of the invention is merely to facilitate discussion of the present invention, and it is envisioned that those skilled in the art may devise various modifications and equivalents without departing from the scope of the appended claims.

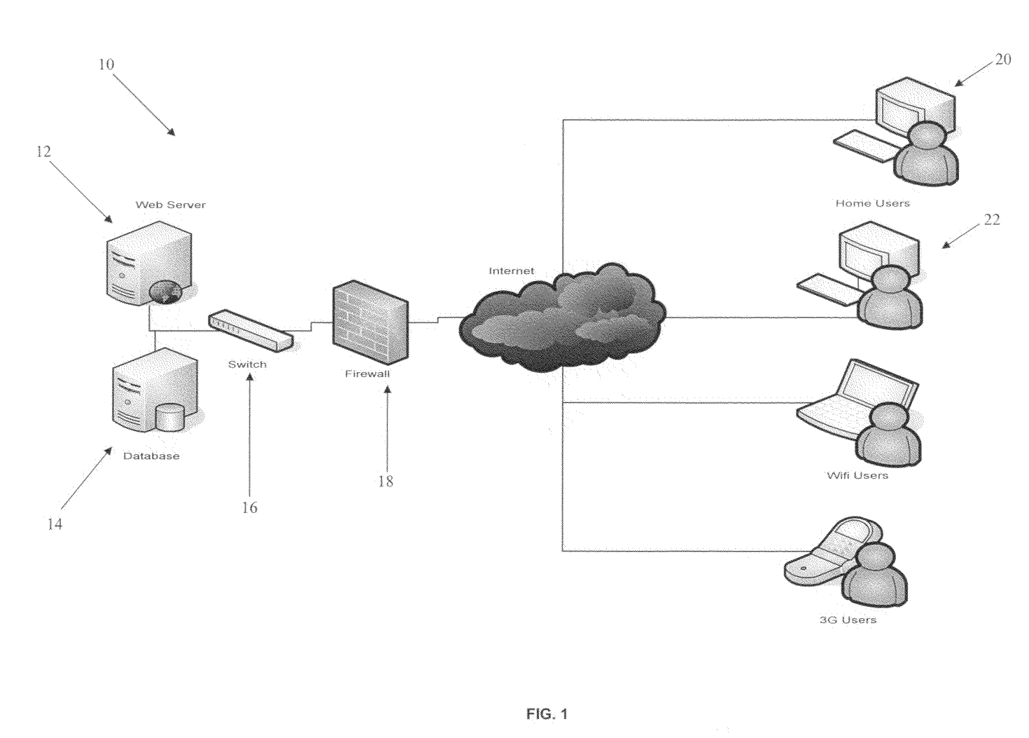

FIG. 1 shows the online transaction system (10) according to the preferred embodiments of the present invention. The system (10) enables a registered merchant to post his product or service, and a registered purchaser to view and purchase the product and service.

Preferably, the system (10) of the present invention gathers a community of consumers and sellers to offer or purchase products or services at lower price through bulk product or service purchases. However, it must be appreciated that the system (10) can also be utilized for single purchasing also.

The system (10) includes two major entities: (1) registered merchants who create a new transaction by stating his offer and the total purchasers required; and (2) registered purchasers that commit themselves to participate in the entire bulk buying process. The system (10) enables a registered merchant to post details about his product or service and likewise enable registered purchasers to view and make inquiries about the product and service. The system (10) will gather sufficient registered purchasers in the transaction to complete the bulk purchases.

The system (10) preferably uses a redundant array of independent (or inexpensive) disks (“RAID”) software configuration to provide redundancy and backup supply of data. The entire system (10) is run using open source technology operating systems currently available, such as Red Hat Linux, Thttpd, Apache, OpenSSL, PHP4, PHP5 and MySQL, and particularly, MySQL5. This allows the flexibility of customization and integration of the system (10). XML integration allows the system (10) to communicate with other devices.

Preferably, the system (10) operates on the basis of membership. Any individual or group of individuals or corporations who want to conduct transactions using the system (10) must register himself as a member. This can be done by simply signing up using any one of known registration procedures.

The system (10) utilizes either a web server (12), a database server (14) or both, although it is preferable that at least a web server (12) be used. In the preferred embodiments of the present invention, the web server (12) or the database server (14) used are standard x86 architecture servers. By having a web server (10), registered merchants can update the server by any means of Internet connection such as WAP, 3G, GPRS etc. Registered members are also able access the system (10) through SMS, MMS and other mobile messaging technologies.

The moderators of the system (10) use a first remote computer (16) which is connected to the web server (12) and/or database server (14) to a security authentication server (18). The moderators upload the quantity of the product or service sold by a merchant and quantity of the product or service acquired by a purchaser, which are updated in real-time using the first remote computer (16).

In the preferred embodiments of the present invention, the security authentication server (18) used includes a 128-bit encryption Security Socket Layer (SSL) protocol and firewall encryptions. As is usual, the introduction of the security authentication server (18) is to prevent hackers from illegally obtaining merchants' and purchasers' account details and personal information. However, it must be noted that the security authentication server (18) can be selected from other types of security authentication servers.

The system (10) allows moderators to actively monitor all of the transactions. If there are any activities that seem suspicious, moderators can intervene and suspend the posting of the product or service, or its purchase. The system (10) also provides a message board on each item posted, that allows both merchants and purchasers to write their opinions on any particular product or service. The message board acts as a mechanism that informs other users if a fraud is detected. The system (10) has its own ranking system; hence a member who is on the higher rung of the ranking system will automatically indicate that he is more trustworthy, and therefore, he can be relied on. The ranking will be given by looking at the member's past transactions, and can be upgraded or downgraded depending on his current performances.

Merchants use a second remote computer (20) to update details of the product or service in the web server (12) and/or database server (14) in real-time. Therefore, the web server (12) and/or database server (14) maintain(s) the latest information regarding available products and services.

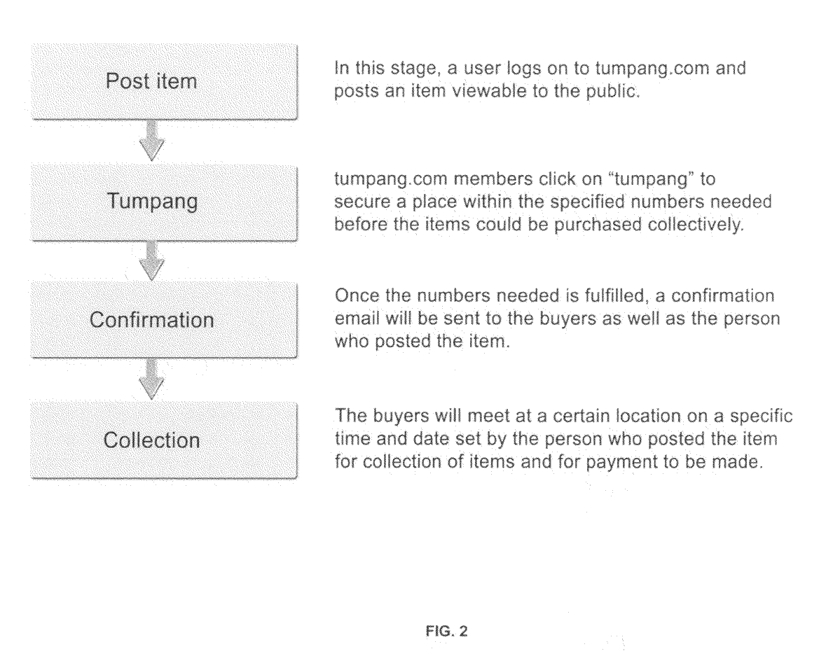

Reference is now made to FIG. 2, wherein the method by which a single transaction is conducted using the system (10) according to the preferred embodiments of the present invention has been illustrated. There are two main features of the system (10). One feature is the posting of items for a sale by a merchant or a group of merchants, and the other feature is the purchase of the items by an individual buyer or a group of buyers.

In the posting of items, a registered merchant must log in using his user name and user password. Access will be denied if either the user name or user password, or both, are keyed in wrongly. The registered merchant must then specify details of the products or services he is posting and he will be required to confirm the details to be correct before the items are uploaded and made viewable to potential purchasers.

The details of the products or services which can be created or updated include market price, bulk purchase price, number of purchasers required for the bulk purchase transaction, number or quantity of the product and service required for the bulk purchase transaction, the location of the actual monetary transaction, location of the actual product/service collection and the opening and closing date of the bulk purchase.

In order for registered merchants to post their products or services in the system (10), they will have to use a credit system referred to as “toints.” The higher the toints a registered merchant or registered purchaser has accumulated in the successful transactions, the higher he will be on the ranking system, therefore reflecting a better image of the merchant or purchaser as being a trustworthy merchant or purchaser. Under the toints system, no actual currency is reflected, hence preventing a sense of wariness of using actual currency; instead the toints incorporate the culture of using virtual currency.

The merchants will initially be supplied a number of toints. However, if they have utilized all of their toints points, they can purchase toints through various payment gateways, such as credit cards, e-banking, e-wallets, etc. The system (10) will also be connected to the merchant banks via an Application Programming Interface (API) that is provided by the merchant bank.

In purchasing an item from the system (10), the registered purchaser must log in into a third remote computer (22) using his user name and user password. As mentioned above, access will be denied if either the user name or user password, or both, are keyed in wrongly. Products and/or services which have been uploaded can be viewed and purchased. If the purchaser wants to make a purchase, he can secure the product or service by placing his order.

A confirmation communication such as a fax, email, SMS, etc., will then be sent to both the merchant and purchaser to confirm that the purchaser is interested in purchasing the product or service. The registered merchant who posted the details of products or services that the registered merchant is interested in will then inform the registered purchaser the location where the purchaser can view the actual product or service and collect the same via fax, email, SMS, etc. The actual transaction and actual monetary transaction are therefore conducted independently. The net result is the real-time sale or purchase of a product or service using the Internet.

The present invention is aimed at giving the worldwide community the convenience of purchasing products and/or services online without any hassle. Regardless of any age and socioeconomic background, anyone can benefit from the present invention as long as they have a computer and an Internet connection. Retailers and business owners also benefit from the present invention, as they will be able to gain access to the system to post products and services.

Furthermore, through the present invention, consumers everywhere in the world will be able to benefit from purchasing products and services in a cheaper way, thus boosting the society's economy. Consumers will also be able to interact and discuss products and services posted online. This will not only encourage wise buying, but also create an online community where people can go to buy products and/or services and spend wisely.

Also, through the present invention, consumers everywhere will be able to log on and purchase items at a lower price. Through this, the socio-economic level of the people will improve, as purchases will be done in a wise way and with much thought.

Since the present invention is web-based, it is accessible from anywhere with Internet access. Users can use all types of Internet connection means, such as broadband, 3G, GPRS, WiMax to conduct the desired online transactions.

For the purposes of this patent application, a registered merchant includes individuals and companies who sell or offer to sell products or services whereas a registered purchaser includes individuals and companies who want to purchase the products or services.

1. An online transaction system for enabling a merchant to post details relating to a product or service and for enabling a purchaser to view and purchase the product or service, the system comprising:
at least a web server and/or at least a database server;
a first remote computer connecting the web server and/or database server to a security authentication server; and
memory for specifying and storing a minimum quantity of said product or service which must be purchased to consummate a transaction, wherein said system authorizes a transaction when one or more purchasers agree to purchase at least said specified quantity of products or services.

2. The system of claim 1, wherein the details relating to said product or service are created and updated by the merchant in real-time via a second remote computer.

3. The system of claim 1, wherein the purchaser purchases a particular product or service in real-time using a third remote computer.

4. The system of claim 1, wherein details relating to the transaction and status of the merchant or purchaser are updated in real-time using the first remote computer.

5. The system of claim 1, wherein the quantity of the product or service acquired by a purchaser is updated in real-time using the first remote computer.

6. The system of claim 1, wherein the security authentication server comprises a 128-bit encryption Security Socket Layer protocol and firewall encryptions.

7. The system of claim 1, wherein the system is accessed via one or more of the following network connections: broadband, 3G, GPRS and WiMax.

8. A method for conducting online transactions comprising the steps of:
posting details about one or more products or services on a server;
providing users with access to said details;
specifying a minimum quantity of said products or services which must be purchased in order to consummate a transaction; and
consummating said transaction when one or more users agree to purchase at least said minimum quantity of said products or services.

9. The method of claim 8, further comprising the step of offering said minimum quantity of products or services at a discounted price.

10. The method of claim 8, further comprising the step of updating said minimum quantity of products or services in real-time.

11. The method of claim 8, further comprising the step of providing a forum on which users can communicate regarding said products or services.

12. The method of claim 8, further comprising the step of ranking sellers and/or buyers of said products or services.

13. The method of claim 12, further comprising the step of setting a minimum number of credits that a buyer of products or services must have in order to accumulate a higher ranking.

14. The method of claim 8, wherein said details comprise one or more of the following relating to said products or services: market price; bulk purchase price; number of purchasers required for a bulk purchase transaction; quantity of the products or services required for the bulk purchase transaction; location of an actual monetary transaction; location where the actual products or services will be delivered; and an opening and closing date of the bulk purchase.

15. An online transaction system comprising:
a server for storing a minimum quantity of products or services which must be purchased by a user to consummate a transaction;
a webpage for displaying said products or services, wherein the user can purchase said products or services on the web page; and
a processor for processing a transaction, wherein said transaction is consummated only if at least one user agrees to purchase said minimum quantity of said products or services.

16. The system of claim 15, further comprising a security authentication server.

17. The system of claim 15, wherein said server is a web server.

18. The system of claim 15, further comprising a message board on which users can exchange information about products, services, buyers and sellers.

19. The system of claim 15, wherein said processor ranks buyers and/or sellers based on past transactions.

20. The system of claim 15, wherein said server stores one or more of the following types of information relating to said products or services: market price; bulk purchase price; number of purchasers required for a bulk purchase transaction; quantity of the products or services required for the bulk purchase transaction; location of an actual monetary transaction; location where the actual products or services will be delivered; and an opening and closing date of the bulk purchase.
